(19) United States
(12) Patent Application Publication
(10) Pub. No.: US 2007/0262927 A1
(43) Pub. Date: Nov. 15, 2007

(54) Electron emission display device and driving method thereof

(76) Inventors: Dong Hyup Jeon, Cheonan (KR); Mun Seok Kang, Yongin (KR)

Correspondence Address: CHRISTIE, PARKER & HALE, LLP, PO BOX 7068, PASADENA, CA, 91109-7068, US

(21) Appl. No.: 11/594,502

(22) Filed: Nov. 7, 2006

(30) Foreign Application Priority Data
May 9, 2006 (KR) 10-2006-0041472

(51) Int. Cl. G09G 3/22

(52) U.S. Cl. 345/75.2

(57) ABSTRACT

An electron emission display device including: a pixel area for emitting electrons depending on voltage applied to a first electrode and a second electrode; a timing controller for outputting varying pulse widths clocks, the pulse widths of clocks being varied depending on gray scales of image signals. The display device also includes a data driver for generating data signals using the image signals and transferring them to the first electrode; a scan driver generating scan signals and transferring them to the second electrode; and a voltage controller for controlling the voltage of the second electrode depending on the sum of the image signals in one frame interval, wherein the data driver counts the number of the clock pulses to control the pulse widths of the data signals.

### CROSS-REFERENCE TO RELATED APPLICATIONS

This application claims priority to and the benefit of Korean Patent Application No. 2006-41472, filed on May 09, 2006, in the Korean Intellectual Property Office, the disclosure of which is incorporated herein by reference.

### BACKGROUND

1. Field of the Invention

The present invention relates to an electron emission display device and driving method thereof, and more specifically, to an electron emission display device and driving method thereof for reducing power consumption and enhancing image quality.

2. Discussion of Related Art

FIG. 1 is a block diagram showing an electron emission display device according to prior art. Referring to FIG. 1, the electron emission display device comprises a pixel area 10, a data driver 20, a scan driver 30, and a timing controller 40.

In the pixel area 10, pixels 11 are formed at the overlapping portions of cathode electrodes C1, C2, . . . , Cn and gate electrodes G1, G2, . . . , Gn. The pixel 11 comprises an electron emitter so that electrons emitted from cathode electrode of the electron emitter impact on an anode electrode to light-emit phosphors for displaying gray scale image. The gray scales of images displayed vary depending on digital image signal input values. To control the gray scales (images) displayed according to the digital image signal values, a pulse width modulation scheme or a pulse amplitude modulation scheme can generally be used.

The data driver 20 uses an image signal to generate a data signal and is connected to the cathode electrodes C1, C2, . . . , Cn to apply the data signal to the pixel area 10 so that the pixel area 10 is light-emitted depending on the data signal.

The scan driver 30 is connected to the gate electrodes G1, G2, . . . , Gn to generate a scan signal and transfer it to the pixel area 10 so that the pixel area 10 is sequentially light-emitted in a constant time in a horizontal line unit by a line scan scheme to display a full screen.

A timing controller 40 controls the data driver 20 and the scan driver 30 to generate the data signal and the scan signal.

However, an electron emission display device constructed as above has problems in that if the number of pixels 11 is large, current flowing into the pixels becomes large and therefore increases power consumption and shortens the lifetime of the electron emitter.

### SUMMARY OF THE INVENTION

In once embodiment, the present invention provides an electron emission display device and driving method thereof for reducing power consumption and enhancing image quality by restricting the amount of current flowing into the pixel area, depending on the sum of image signals.

In one embodiment, the present invention is an electron emission display device comprising: a pixel area emitting electrons according to voltage applied to a first electrode and a second electrode and comprising an anode electrode on which the electrons emitted are impacted; a timing controller for outputting varying pulse widths clocks, wherein the pulse widths of the clocks are varied depending on gray scales of image signals; a data driver generating data signals using the image signals and applying them to the first electrode; a scan driver generating scan signals and applying them to the second electrode; and a voltage controller controlling voltages of the first electrode and the second electrode, wherein the voltage of the second electrode is controlled depending on the sum of the image signals input in one frame interval, and wherein the data driver counts the number of the clock pulses output from the timing controller.

In one embodiment, the present invention is an electron emission display device comprising: a pixel area emitting electrons depending on voltage applied to a first electrode and a second electrode and comprising an anode electrode on which the electrons emitted are impacted; a voltage controller controlling voltages of the first electrode and the second electrode, wherein the voltage of the second electrode is controlled according to the sum of the image signals input in one frame interval; a data driver generating data signals using the image signals and applying them to the first electrode; and a scan driver generating scan signals and applying them to the second electrode, wherein the data driver counts the clock pulses of which the pulse widths are varied according to the gray scales of the image signals and controls the pulse widths of the data signals according to the number counted.

In one embodiment, the present invention is a driving method of an electron emission display device, which emits electrons depending on voltage applied to a first electrode and a second electrode and displays an image by being impacted with the emitted electrons. The method includes calculating the sum of image signals in one frame interval by receiving the image signals; controlling the voltage of the second electrode by the sum of the image signals; counting clock pulses of which the pulse widths are varied according to the gray scales of the image signals input; and outputting data signals in response to counting the clock pulses.

### BRIEF DESCRIPTION OF THE DRAWINGS

FIG. 1 is a block diagram showing an electron emission display device according to prior art;

FIG. 2 is a block diagram of an electron emission display device according to the present invention;

FIG. 3 is a graph showing the relationship between the sum of image signals and gate voltage of an electron emission display device according to the present invention;

FIG. 4 is a block diagram of a voltage controller adopted in an electron emission display device;

FIG. 5 is a block diagram of a data driver adopted in an electron emission display device;

FIGS. 6A and 6B are exemplary clock pulses input to a data driver; and

FIGS. 7A and 7B are timing diagrams showing the operation of the data driver according to the clock pulses shown in FIG. 5.

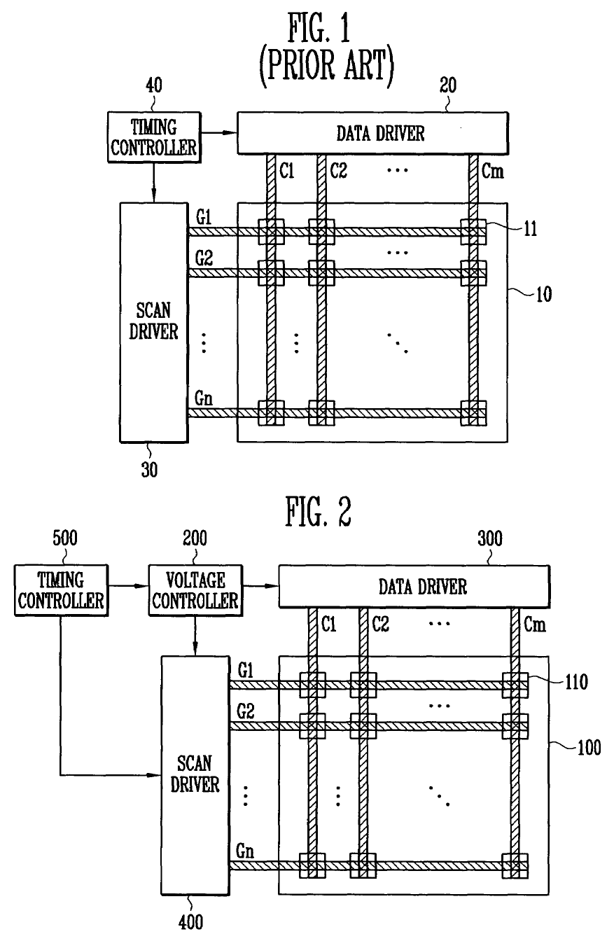

### DETAILED DESCRIPTION

FIG. 2 is a block diagram of an electron emission display device according to the present invention. Referring to FIG. 2, the electron emission display device comprises a pixel area 100, a voltage controller 200, a data driver 300, a scan driver 400, and a timing controller 500.

In the pixel area 100, pixels 101 are formed at the overlapping portions of cathode electrodes C1, C2, . . . , Cn and gate electrodes G1, G2, . . . , Gn, wherein the pixels 110 comprise electron emitters so that electrons emitted from cathode electrodes of the electron emitters impact on their respective high voltage anode electrodes to emit light on phosphors for displaying images. The gray scales of the images displayed vary depending on digital image signal input values. In one embodiment, to control the displayed gray scales depending on the digital image signal values, a pulse width modulation scheme is used.

The voltage controller 200 sums the image signals to control the respective voltages of the gate electrodes G1, G2 . . . Gn and the respective voltages applied to the cathode electrodes C1, C2 . . . Cn, depending on the voltage variations of the respective gate electrodes G1, G2 . . . Gn. If the voltage controller 200 increases the voltages of the gate electrodes G1, G2 . . . Gn first, the voltage difference between the gate electrodes G1, G2 . . . Gn and the cathode electrodes C1, C2 . . . Cn would be substantially high to cause a problem of back light emission. Therefore, in order to solve the problem of back light emission, the voltages of the cathode electrodes C1, C2 . . . Cn should also be increased.

The data driver 300 uses an image signal to generate a data signal, and is connected to the cathode electrodes C1, C2, . . . , Cn to apply the data signal to the pixel area 100 so that the pixel area 100 is light-emitted depending on the data signal.

The data driver 300 displays portions of low gray scale (images) in a better quality by making light-emitting time differences between the respective gray scales when displaying the low gray scales greater than light-emitting time differences between the respective gray scales when displaying high gray scales. If the voltages of the gate electrodes G1, G2 . . . Gn and the voltages of the cathode electrodes C1, C2, . . . , Cn are increased by the voltage controller 200, the voltage differences of the gate electrodes G1, G2 . . . Gn and the cathode electrodes C1, C2, . . . , Cn are reduced and thus, emission currents corresponding to the voltage differences of the gate electrodes G1, G2 . . . Gn and the cathode electrodes C1, C2, . . . , Cn are reduced, thereby reducing maximum luminance of the pixel. If the maximum luminance for the pixel is reduced, the luminance differences between the respective gray scales are reduced so that the pixels with low gray scales may not be displayed well.

The scan driver 400 is connected to the gate electrodes G1, G2, . . . , Gn to generate a scan signal and transfers it to the pixel area 100 so that the pixel area 100 is sequentially light-emitted by a constant time in a horizontal line unit using a line scan scheme to display a full screen. Therefore, the scan driver can be driven with reduced circuit cost and power consumption.

The timing controller 500 outputs an image signal, a data driver controlling signal, and a scan driver controlling signal to the data driver 300 and the scan driver 400 to operates the data driver 300 and the scan driver 400 for displaying an image on the pixel area 100. Also, the timing controller 500 outputs to the data driver 300 a clock pulse of which the pulse width is varied, so that the pulse width of the data signal can be determined using the clock pulse in the data driver 300.

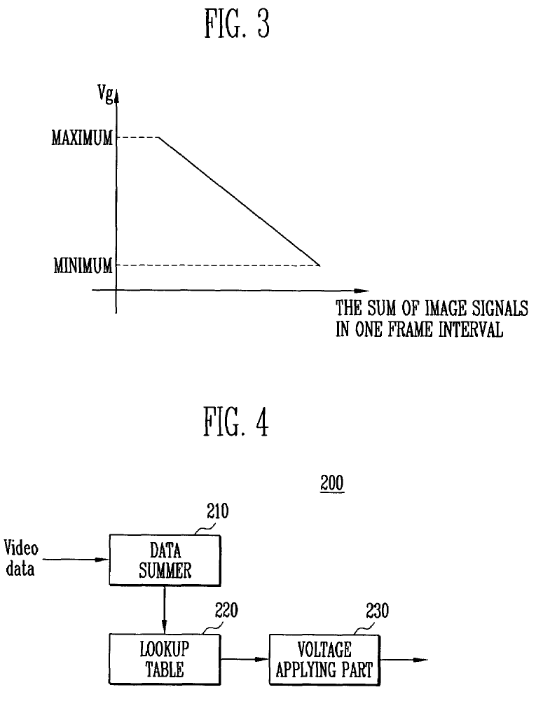

FIG. 3 is a graph showing the relationship between the sum of image signals and gate voltage. Referring to FIG. 3, a horizontal axis represents the sum of image signals input in one frame interval, and a vertical axis represents the voltage Vg of a gate electrode.

The sum of the image signals means the sum of the image signals input in one frame interval. If the sum of the image signals is large, it means that a corresponding frame includes many pixels emitting light in a high luminance manner, and if the sum of the image signals is small, it means that that frame includes a few pixels emitting light in a high luminance manner.

Accordingly, if the sum of the image signals is large, the pixel luminance is high so that substantial current flows into the pixels, and if the sum of the image signals is small little current flows. Consequently, as the magnitude of the gate voltage is controlled depending on the sum of the image signals, the amount of current flowing into a pixel is controlled, thereby controlling the pixel luminance.

FIG. 4 is a block diagram showing a structure of a voltage controller adopted in an electron emission display device according to one of the embodiments of the present invention. Referring to FIG. 4, the voltage controller 200 comprises a data summer 210, a lookup table 220, and a voltage applying part 230.

The data summer 210 adds all of video data (image signals) input during one frame interval, wherein if the video data displays a high gray scale, the magnitude thereof is large, and if the video data displays a low gray scale, the magnitude thereof is small. Consequently, if the sum of the video data is large, it means that the number of the pixels emitting light in a high luminance is large, and if the sum of the video data is small, it means the number of the pixels emitting light in a high luminance is small.

The lookup table 220 stores the voltages of the gate electrodes corresponding to the sum of the video data so that each of the voltages of the gate electrodes has a one-to-one correspondence to each of the sum of the video data. The lookup table 220 also stores the voltages of the cathode electrodes having a one-to-one correspondence with the voltages of the gate electrodes. Therefore, if the sum of the video data is calculated in the data summer 210, the respective voltages of the gate electrodes corresponding to the sum of the video data are retrieved from the lookup table. Also, the voltages of the cathode electrodes C1, C2, . . . Cn to be varied are retrieved from the lookup table 220 corresponding to the retrieved voltages of the gate electrode.

The voltage applying part 230 applies voltages to the gate electrodes G1, G2, . . . , Gn and the cathode electrodes C1, C2, . . . Cn, respectively, corresponding to the voltages of the gate electrodes and the cathode electrodes stored in the lookup table 220 to control the voltage differences of the gate electrodes G1, G2, . . . , Gn and the cathode electrodes C1, C2, . . . Cn, thereby preventing the problem of the back light-emission.

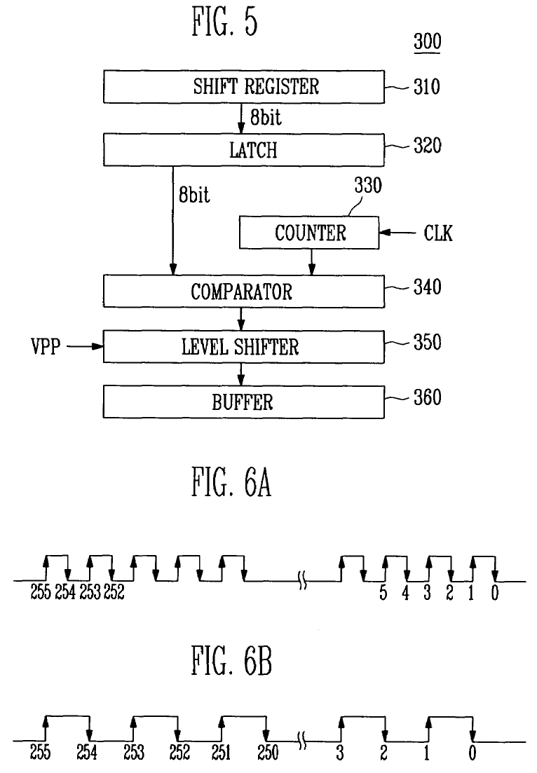

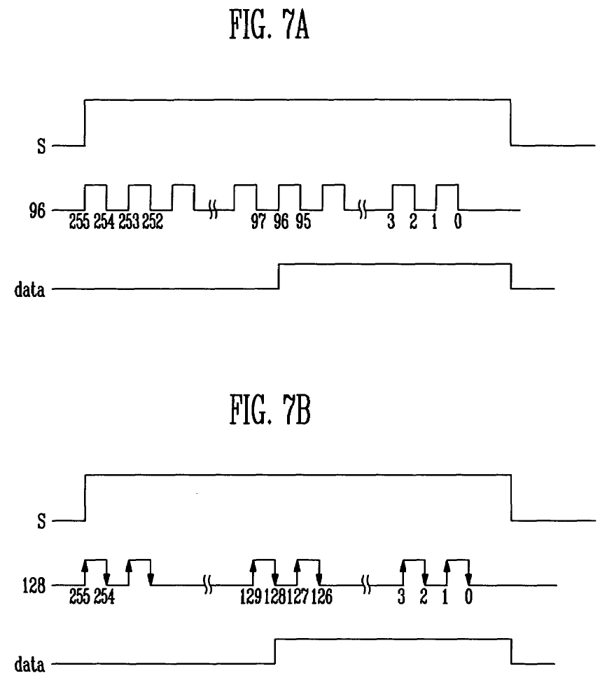

FIG. 5 is a block diagram of a data driver adopted in an electron emission display device. FIGS. 6A and 6B are clock pulses input to the data driver 300. Referring to FIG. 5, the data driver 300 includes a shift register 310, a latch 320, a counter 330, a comparator 340, a level shifter 350, and a buffer 360.

The shift register 310 receives image signals in series and transfers them to the latch 320. The latch 320 then transfers the image signals to the comparator 340 in parallel. In case that the gray scales of the image signals are displayed as 8 bit, the counter 330 counts the clock pulses to count down numbers from 255 to 0 using the clocks. If the input gray scales of the image signals are high, the clock pulses having small pulse widths are input to the counter, as shown in FIG. 6A. If the input gray scales of the image signals are low, the clock pulses having large pulse widths are input to the counter, as shown in FIG. 6B.

Further, the comparator 340 compares data input from the latch 320 with data input from the counter 330 to output a signal when the value of the image signals matches the value of the counter 330. The signals output from the comparator 340 are input to the buffer 360 through the level shifter 350 to be output as the data signals. Accordingly, the light-emitting time differences between the respective gray scales become greater in lower gray scale pixels than in high gray scale pixels, in the data signals. As the differences of the input gray scales are greater, the gray scale difference is explicitly displayed, resulting in a better display of the low gray scale pixels.

FIGS. 7A and 7B are timing diagrams showing the operation of the data driver according to the pulse width modulation scheme shown in FIG. 5. Referring to FIGS. 7A and FIG. 7B, the pulse width modulation scheme can display 8 bit gray scales, and generate the data signals depending on the input gray scales of the image signals to control the light-emitting times of the pixels 110 for displaying each gray scale, while scan signals are input through the scan driver 400.

The scan signal S is maintained in a high state during a constant time, and the counter 330 counts clocks while the scan signal S is maintained in the high state. The counter 330 counts the rising time and the falling time of the clocks, respectively. That is, if the first clock is input to the counter 330, the rising time of the clock is 255 and its falling time is 254.

Further, the comparator 340 outputs signals when the values for the input gray scales of the image signals input from the latch is identical with the values counted in the counter 330. In case that the input gray scale of the image signal is 96 as shown in FIG. 7A, if the counter 330 begins to count from 255 and arrives at time point 96, the comparator outputs a signal to make the data signals to be in a high state. Similarly, in case that the input gray scale of the image signal is 128 as shown in FIG. 7B, if the counter 330 begins to count from 255 and arrives at time point 128, the comparator outputs a signal to make the data signals to be in a high state. Accordingly, since the input gray scale of the time point 128 arrives sooner than the input gray scale of the time point 96, the data signal is maintained in the high state longer for the input gray scale of 128 than the input gray scale of 96. This results in displaying the input gray scale of 128 with a higher luminance.

The pulse width modulation scheme as described above is convenient in operation due to the linear relationship between the pulse width and the amount of current emitted.

Therefore, the electron emission display device and driving method thereof of the present invention controls the voltage difference of the cathode electrode and the gate electrode depending on the sum of the image signals of the electron emission display device and prevents the deviation of gamma correction generated accordingly, thereby enhancing image quality displayed on the electron emission display device. The driving method of the invention also reduces power consumption of the electron emission display device and enhances lifetime of the electron emitter.

Although some embodiments of the present invention have been disclosed using specified terms, they are used for purposes of description only. It would be appreciated by those skilled in the art that changes and modifications might be made in this embodiment without departing from the principles and spirit of the invention.

What is claimed is:

1. An electron emission display device comprising:
a pixel area for emitting electrons according to voltage applied to a first electrode and a second electrode and comprising an anode electrode on which the electrons emitted are impacted;
a timing controller for outputting varying pulse widths clocks, wherein pulse widths of the clocks are varied according to gray scales of image signals;
a data driver for generating data signals according to the image signals and applying the data signals to the first electrode;
a scan driver for generating scan signals and applying the scan signals to the second electrode; and
a voltage controller for controlling voltages of the first electrode and the second electrode, wherein the voltage controller controls the voltage of the second electrode according to the sum of the image signals in one frame interval, and
wherein the data driver counts the number of the clock pulses output from the timing controller.

2. The device according to claim 1, wherein the voltage controller controls the voltage of the second electrode utilizing a lookup table in which the voltage of the second electrode corresponding to a sum of the image signals is stored.

3. The device according to claim 1, wherein the voltage of the first electrode varies depending on voltage variation of the second electrode.

4. The device according to claim 1, wherein the pulse width of a clock is small if the gray scale of an image signal is large, and the pulse width of the clock is large if the gray scale of the image signal is small.

5. The device according to claim 1, wherein the data driver outputs the data signals at the same time points as the gray scales of the image signals according to the number of clocks counted.

6. An electron emission display device comprising:
a pixel area for emitting electrons depending on voltage applied to a first electrode and a second electrode and comprising an anode electrode on which the electrons emitted are impacted;
a voltage controller for controlling voltages of the first electrode and the second electrode, wherein the voltage of the second electrode is controlled according to sum of image signals in one frame interval;
a data driver for generating data signals according to the image signals and applying the data signals to the first electrode; and
a scan driver for generating scan signals and applying the scan signals to the second electrode,
wherein the data driver counts number of clock pulses with pulse widths varying according to gray scales of the image signals, and controls pulse widths of the data signals according to the number of clock pulses counted.

7. The device according to claim 6, wherein the data driver comprising:
a shift register for receiving the image signals in series;
a latch connected with the shift register for outputting the image signals in parallel;
a counter for receiving the clock pulses and counting the clock pulses; and
a comparator for comparing the number of the clock pulses counted in the counter with the image signals output from the latch and outputting a signal when the number of the clock pulses counted is with the same as the sum of the image signals.

8. The device according to claim 6, wherein the voltage controller comprising:
a data summer for summing the image signals in one frame;
a lookup table for storing the voltage of the second electrode corresponding to the sum of the image signals; and
a voltage applying part for applying a voltage corresponding to the voltage of the second electrode stored in the lookup table to the second electrode.

9. The device according to claim 6, wherein the voltage of the first electrode varies depending on the voltage variation of the second electrode.

10. The device according to claim 6, wherein the pulse width of a clock is small if the gray scale of an image signal is large, and the pulse width of the clock is large if the gray scale of the image signal is small.

11. A driving method of an electron emission display device, which emits electrons depending on voltage applied to a first electrode and a second electrode and displays an image by being impacted with the emitted electrons, the method comprising:
receiving a plurality of image signals;
calculating a sum of image signals in one frame interval;
controlling the voltage of the second electrode according to the calculated sum of the image signals;
counting clock pulses with pulse widths varying according to gray scales of the image signals; and
outputting data signals in response to counting the clock pulses.

12. The method according to claim 11, further comprising varying the voltage of the first electrode corresponding to the controlled voltage of the second electrode

13. The method according to claim 11, wherein if the gray scale value of the image signal is high, the pulse width of the clock is short, and if the gray scale value of the image signal is low, the pulse width of the clock is long.

14. The method according to claim 11, wherein the step of controlling the voltage of the second voltage is performed using a lookup table storing the voltage of the second electrode.

15. A method for driving pixels of an electron emission display device having a first electrode and a second electrode, the method comprising:
receiving video data including data representative of a gray scale level;
calculating a sum of the gray scale levels for one frame interval;
controlling the voltage of the second electrode in response to the calculated sum of the gray scale levels; and
outputting data signals in response to counting the clock pulses.

16. The method of claim 15 further comprising counting clock pulses with pulse widths varying according to gray scales of the image signals input.

17. The method of claim 15 further comprising varying the voltage of the first electrode corresponding to the controlled voltage of the second electrode.

18. The method of claim 15, wherein if the gray scale level increases, the pulse width of the clock decreases, and if the gray scale value of the image signal decreases, the pulse width of the clock increases.

19. The method of claim 15, wherein the step of controlling the voltage of the second voltage comprises storing the voltage of the second electrode in a look up table and retrieving the voltage of the second voltage from the look up table.

20. The method of claim 15, further comprising reducing the pulse width of a clock if a gray scale level is large, and increasing the pulse width of the clock if the gray scale is small.
